(19) United States
(12) Patent Application Publication
(10) Pub. No.: US 2014/0204070 A1
(43) Pub. Date: Jul. 24, 2014

(54) LIQUID CRYSTAL DISPLAY APPARATUS AND DRIVING METHOD THEREOF

(71) Applicant: RAYDIUM SEMMICONDUCTOR CORPORATION, Hsinchu City (TW)

(72) Inventors: WEN-TSUNG LIN, TAINAN CITY (TW); CHIEN-RU CHEN, TAINAN CITY (TW); YING-LIEH CHEN, TAINAN CITY (TW)

(21) Appl. No.: 13/903,012

(22) Filed: May 28, 2013

(30) Foreign Application Priority Data
Jan. 18, 2013 (TW) 102102022

(51) Int. Cl. G09G 3/36

(52) U.S. Cl. CPC G09G 3/36
USPC 345/212; 345/87

(57) ABSTRACT

A driving method is disclosed, and the driving method is applied into a liquid crystal display apparatus. The driving method includes steps as follows: receiving an original display data; rearranging the original display data to a new display data according to at least one scan driving mode; adjusting sequence of scan driving corresponding to the scan driving mode according to a sequence signal; transmitting the new display data to a display panel through data line, wherein sequence of the original display data corresponds to sequence of scan driving before adjusting, and sequence of the new display data corresponds to sequence of scan driving after adjusting according to the scan driving mode.

### BACKGROUND OF THE DISCLOSURE

1. Field of the Disclosure

The present disclosure relates to a driving method of a liquid crystal display apparatus; in particular, to a driving method related to improving an operating temperature.

2. Description of Related Art

With the progress in civilization, an image device has become a usual product in daily lives of people, and a display apparatus is an indispensable component of the image device. A user accesses data with the display apparatus, and even controls an operation of the image device through the display apparatus. In addition, a liquid crystal display, LCD, has been broadly applied to all kinds of products which are in need of a liquid crystal display apparatus due to advantages such as a less volume and weight, and a relatively low consumption of power; in recent years, there is even a trend of the liquid crystal display apparatus becoming a substitution for a cathode ray tube, CRT. The liquid crystal display apparatus has been broadly applied to televisions, notebooks, computers, mobile phones, personal digital assistants due to the advantages such as the less volume and weight, and the relatively low consumption of power.

However, with a size of a display panel getting bigger, then a resolution of the display panel is getting higher, and a RC loading of the display panel is also getting more, which leads to operating temperatures of all driving circuits also getting higher. Therefore, to economize a power consumption of driving a circuit to reduce the operation power possibly becomes an important issue.

### SUMMARY OF THE DISCLOSURE

The instant disclosure provides a liquid crystal display apparatus, and the liquid crystal display apparatus includes a display panel, a timing controller, a data driver, and a scan driver. The timing controller receives an original display data. The data driver is coupled to the timing controller and the data driver receives an original display data and rearranges the original display data into a new display data through a line buffer accordingly to at least a scan driving mode, and transmits the new display data to the display panel through the data line. The scan driver is coupled to the timing controller, and the scan driver receives an order signal transmitted by the data driver, and adjust a sequence of scan driving corresponding to the scan driving mode according to the order signal. Among the above, a sequence of the original display data corresponds to the sequence of scan driving before adjusting, and a sequence of the new display data corresponds to the sequence of scan driving after adjusting.

In an embodiment of the instant disclosure, when the data driver rearranges the original display data into the new display data according to the scan driving mode, the data driver transmits the order signal to the scan driver to adjust the sequence of scan driving according to the scan driving mode.

In the embodiment of the instant disclosure, the scan driver includes M scan sub-circuits, and the display panel is divided into M display blocks; according to the control signal, each of the scan sub-circuits transmits N scan driving signals to the display blocks corresponded, wherein M and N are positive integers.

In the embodiment of the instant disclosure, according to the order signal, each of the scan sub-circuits adjusts the sequence of scan driving so as to correspond to the scan driving mode.

The instant disclosure further provides a driving method, and the driving method is applied to a liquid crystal display apparatus. The driving method includes steps as follows: receiving an original display data; rearranging the original display data to a new display data according to at least a scan driving mode; adjusting a sequence of scan driving so as to correspond to the scan driving mode according to a control signal; transmitting a new display data to a display panel through a data line, wherein the sequence of the original display data corresponds to the sequence of scan driving before adjusting, and a sequence of the new display data corresponds to the sequence of scan driving after adjusting according to the scan driving mode.

To sum up, the embodiments of the instant disclosure provide the liquid crystal display apparatus and the driving method thereof, which decreases a number of a high-low level voltage alteration without an image changed, and further reduces the operating temperature of the data driver.

For further understanding of the instant disclosure, reference is made to the following detailed description illustrating the embodiments and examples of the instant disclosure. The description is only for illustrating the instant disclosure, not for limiting the scope of the claim.

### BRIEF DESCRIPTION OF THE DRAWINGS

The description recited below refers to accompanying drawings for a specific instruction of embodiments of the instant disclosure, and thereby the instant disclosure is further understood, and in the accompanying drawings:

FIG. 1 shows a schematic diagram of a liquid crystal display apparatus according to an embodiment of the instant disclosure;

FIG. 2 shows a schematic diagram of a liquid crystal display apparatus according to an embodiment of the instant disclosure;

FIG. 3 shows a schematic diagram of a liquid crystal display apparatus according to an embodiment of the instant disclosure;

FIG. 4 shows a chart of scan driving mode according to an embodiment of the instant disclosure;

FIG. 5 shows a schematic diagram of a data driver rearranging an original display data according to an embodiment of the instant disclosure;

FIG. 6 shows a schematic diagram of a data driver adjusting a sequence of scan driving according to an embodiment of the instant disclosure; and

FIG. 7 shows a flow chart of a driving method according to an embodiment of the instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. In the drawings, the size and relative sizes of layers and regions may be exaggerated for clarity.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below could be termed a second element, component, region, layer or section without departing from the teachings of the instant disclosure. As used herein, the term “and/or” includes any and all combinations of one or more of the associated listed items.

[Embodiment of a Liquid Crystal Display Apparatus]

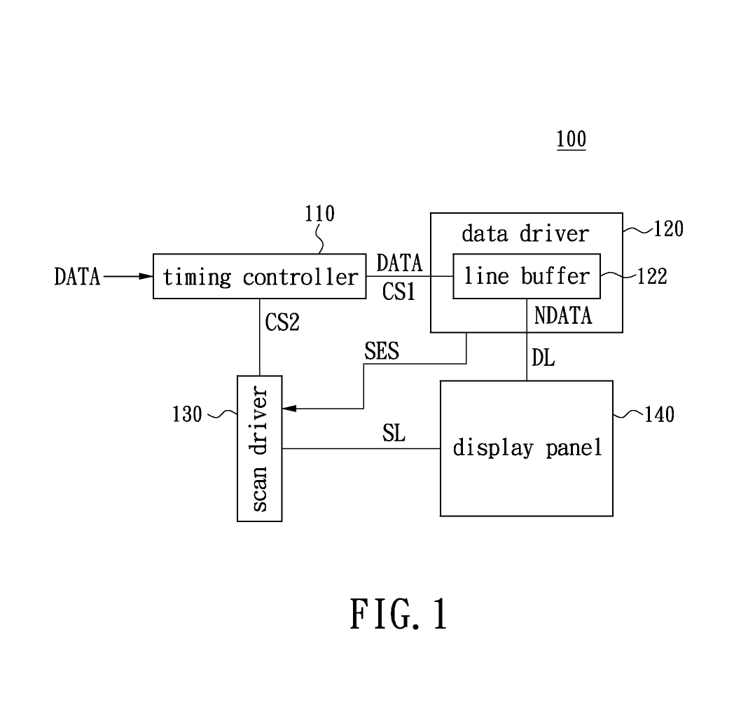

Referring to FIG. 1, FIG. 1 shows a schematic diagram of a liquid crystal display apparatus according to an embodiment of the instant disclosure. In the present embodiment, the liquid crystal display apparatus 100 includes a timing controller 110, a data driver 120, a scan driver 130, and a display panel 140, wherein the data drier 120 includes at least a line buffer 122. The data driver 120 is coupled to the timing controller 110 and the display panel 140. The scan driver 130 is coupled to the timing controller 110 and the display panel 140.

In comparison to a high operating temperature in prior arts, the instant disclosure provides a reduced operating temperature of the data driver 120 through decreasing a number of high-low level voltage alteration inside the data driver 120 under a status that there is no variation of image when the display panel 140 showing an image information. In the present embodiment, the data driver 120 receives an original display data DATA transmitted by the timing controller 110, and the data driver 120 rearranges the original display data DATA into a new display data NDATA according to at least a scan driving mode and through a line buffer 122 inside of the data driver 120, wherein in comparison to the original display data DATA, a difference from the new display data NDATA to the original display data DATA is a sequence of data, and a visual effect shown on the display panel 140 is identical. It is noticed that a sequence of the original display data DATA corresponds to a sequence of scan driving before adjusting, and a sequence of the new display data NDATA corresponds to a sequence of scan driving after adjusting by the timing controller 110 according a scan driving mode. The scan driving mode of the instant disclosure is a mode that decreases a number of the high-low level voltage alteration regarding the original display data DATA while the data driver 120 is transmitting a data driving signal.

In the present embodiment, the data driver 120 provides the data driving signal to the display panel 140 through a data line DL, wherein the data driving signal indicates a grey-scale voltage signal. The data driver 120 receives the new display data NDATA transmitted by the timing controller 110 and a control signal CS1, and rearranges the original display data) DATA into the new display data NDATA through a line buffer 122 according to the scan driving mode set by a user, wherein the new display data NDATA corresponds to the data driving signal.

The scan driver 130 provides a scan driving signal to the display panel 140 through a scan line SL. The scan driver 130 receives a control signal CS2 transmitted by the timing controller 110 and an order signal SES transmitted by the data driver 120 respectively, and adjusts the sequence of scan driving corresponding to the scan driving mode according to the order signal SES. When the data driver 120 rearranges the original display data DATA according to the scan driving mode through the line buffer 122, the data driver 120 also transmits the order signal SES to the scan driver 130 according to the scan driving mode so as to adjust the sequence of scan driving.

Briefly, the data driver 120 of the instant disclosure is able to rearrange the original display data DATA through the line buffer 122 according to the scan driving mode and outputs the new display data NDATA to the display panel 140. In the meantime, the data driver 120 outputs the order signal SES to the scan driver 130 according to the scan driving mode so that the scan driver 130 adjusts the sequence of scan driving. Surely, the sequence of scan driving after adjusting corresponds to the sequence of the new display data NDATA to keep the visual effect on the display panel 140 the same.

For a specific instruction on an operation process of the liquid crystal display apparatus 100 of the instant disclosure, there is at least one of the embodiments for further instruction.

In the following embodiments, there are only parts different from embodiments in FIG. 1 described, and the omitted parts are indicated to be identical to the embodiments in FIG. 1. In addition, for an easy instruction, similar reference numbers or symbols refer to elements alike.

[Embodiment of an Liquid Crystal Display Apparatus]

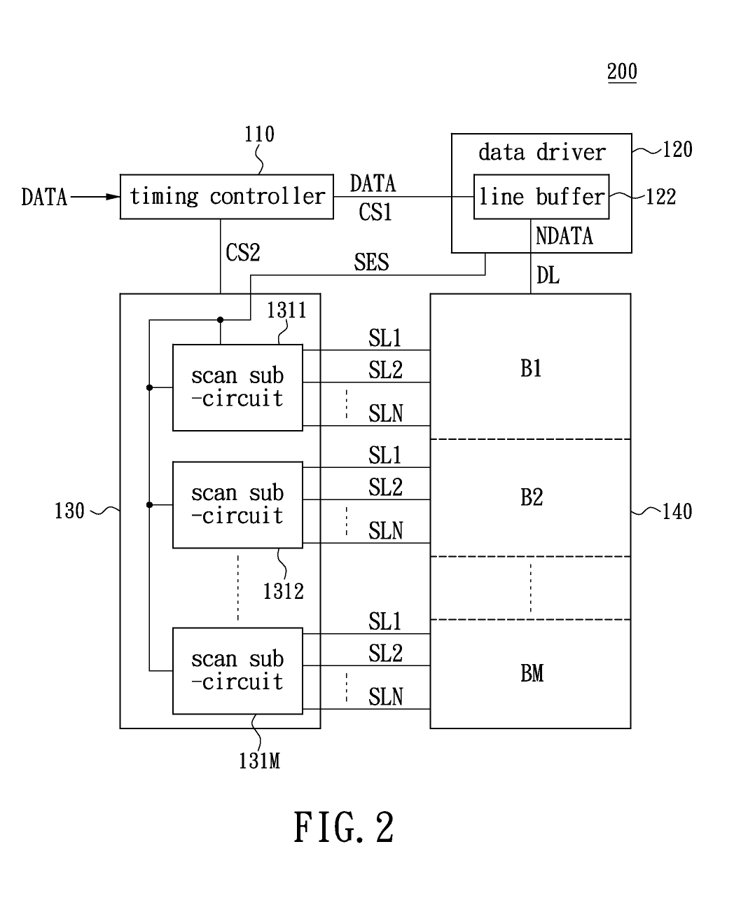

Referring to FIG. 2, FIG. 2 shows a schematic diagram of a liquid crystal display apparatus 200 according to another embodiment of the instant disclosure. Different from the embodiment in the FIG. 1, a scan driver 130 includes a plurality of scan sub-circuits 1311-131M, and a display panel 140 is divided into display blocks B1-BM corresponding to the plurality of the scan sub-circuits 1311-131M. According to an order signal SES received and through the scan lines SL1˜SLN, each of the plurality of the scan sub-circuits 1311˜131M transmits N scan driving signals to the display blocks B1˜BM corresponded, wherein M and N are both integers. Furthermore, each of the plurality of the scan sub-circuits 1311-131M adjusts a sequence of scan driving of the scan driving signals according to the order signal SES received, so as to correspond to the a scan driving mode or to a sequence of a new display data NDATA. It is worth mentioning that, in the present embodiment, for an easy instruction and understanding of the instant disclosure, numbers of the scan lines coupled to the scan sub-circuits 1311-131 are equal; however, in another embodiment, numbers of the scan lines coupled to the scan sub-circuits 1311˜131M may be not equal to each other or only partly equal, and thus it is not limited thereto.

Moreover, after the data driver 120 receives an original display data DATA, the data driver 120 is able to adopt two or even more kinds of scan driving mode and adjust a sequence of the original display data DATA through a line buffer 122, and transmits the new display data NDATA to the display panel 140. In the meantime, the data driver 120 transmits the order signal SES to the scan sub-circuits 1311˜131M according to the scan driving mode adopted, and the scan sub-circuit 1311˜131M adjusts the sequence of scan driving of the scan driving signals according to a sequence adjusting information carried by the order signal SES, so as to correspond to the scan driving modes respectively. Then, through the scan lines SL1-SLN, each of the scan sub-circuits 1311-131M transmits the scan driving signals to the display blocks B1-BM corresponded in the display panel 140. Thus, when the data driver 120 is adopted with different kinds of scan driving modes, the scan driving modes corresponding to the display bocks B1-BM are also different from each other.

To specifically instruct the driving mode of the liquid crystal display apparatus 200 which is able to improve the operating temperature provided by the instant disclosure, there is further instruction demonstrated by a quantitative example (in this example, N=4, M=2) recited below. Generally speaking, when a system is operating a big-sized display panel, a pattern serves as a sign to determine whether an operating temperature is overly high. The description below is an example taken with one of possible patterns, and it is not limited thereto.

[Embodiment of an Liquid Crystal Display Apparatus]

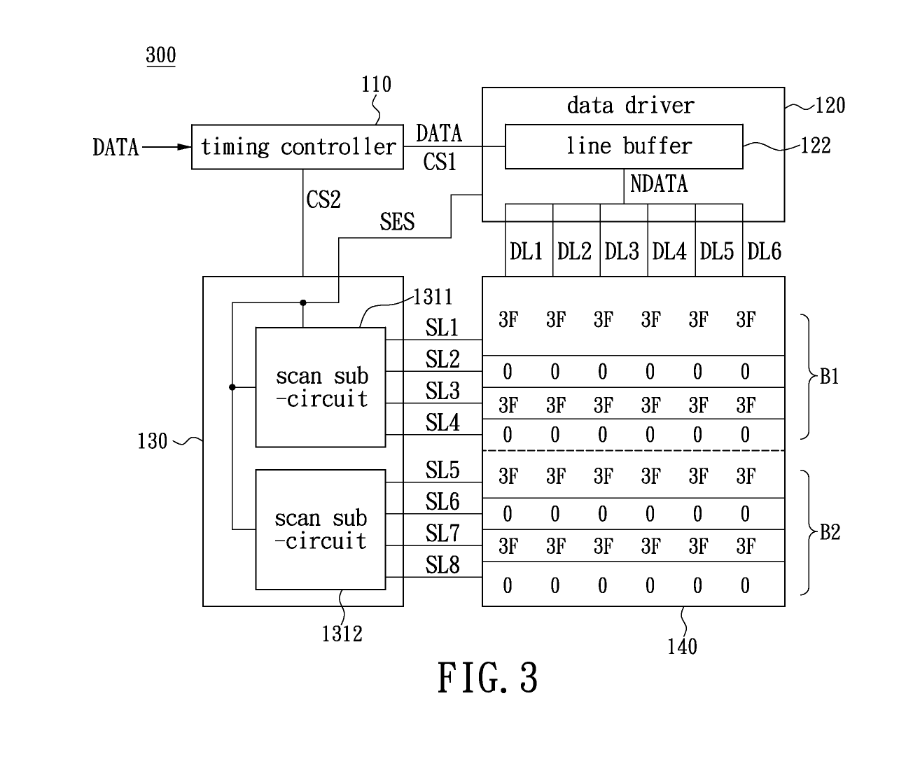

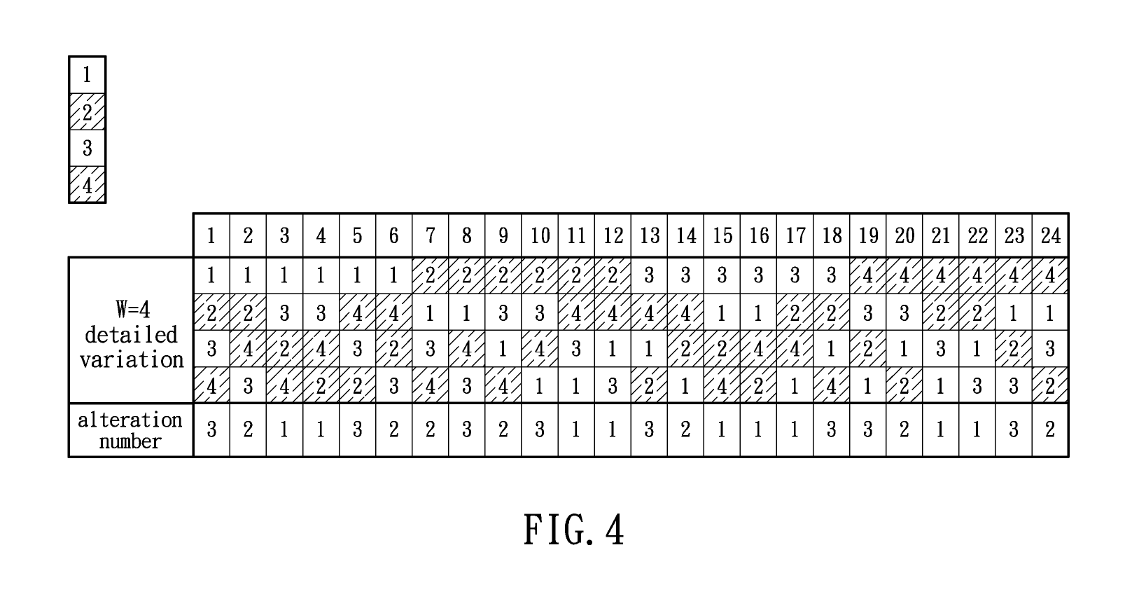

Referring to FIGS. 3 and 4, FIG. 3 shows a schematic diagram of a liquid crystal display apparatus according to an embodiment of the instant disclosure. FIG. 4 shows a chart of scan driving mode according to an embodiment of the instant disclosure. Before further instruction, it is clarified that the following example is assumed that a scan driver 130 has two scan sub-circuits 1311-1312, and the display panel 140 is divided into two display blocks B1-B2, wherein the display block B1 has four scan lines SL1-SL4 coupled to the scan sub-circuit 1311; the display block B2 has four scan lines SL5-SL8 coupled to the scan sub-circuit 1312, wherein the scan sub-circuits 1311 and 1312 correspond to the same scan driving mode; however, in another embodiment, the scan sub-circuits 1311 and 1312 may correspond to different scan driving modes, and it is not limited thereto. The display panel 140 has six data lines DL1-DL6, coupled to the data driver 120. There is a symbol “3F” of the display panel 140 standing for a light spot of a positive polarity or a negative polarity and representing for a high level voltage. There is another symbol “0” of the display panel 140 standing for a dark spot and representing for a low level voltage.

In the chart of FIG. 4, to show the results of all the scan driving modes operated as the scan lines of 4 (N=4), wherein areas with oblique lines stand for dark spots shown, and areas without oblique lines stand for light spots shown. Numbers (such as 1-2-3-4 or 1-2-4-3) stand for a sequence of scan driving of a scan driving signal transmitted by scan lines SL1-SL4 or SL5-SL8; for example, 1-2-4-3 means the sequence of scan driving of the scan driving signal to be from the scan line SL1, to the scan line SL2, and to the scan line SL4, and then to the scan line SL3. Furthermore, FIG. 4 shows an alteration number of a high-low level voltage performed by every possible scan driving mode corresponded. The higher the alteration number is; the more the power consumption of the data driver 120 is, and as a result, the higher the operating temperature of the data driver 120 will be. In the present embodiment, there are 24 kinds of the scan driving modes, wherein 8 kinds of which result in the alteration number of 3 (that is, the operating temperature to be the same as the original situation), and the rest 16 kinds of the scan driving modes result in the alteration number of less than 3 (i.e. the alteration number of 2 or 1, and which means the operating temperature is reduced). Therefore, if it is intended to reduce the operating temperature of the liquid crystal display apparatus 300, then a scan driving mode which is able to result in an operating temperature of less than 3 is adopted by the liquid crystal display apparatus 300.

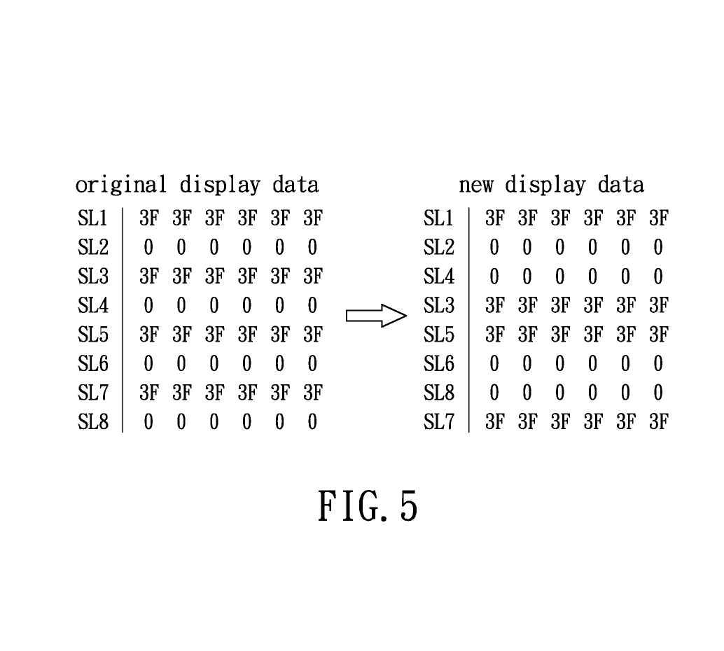

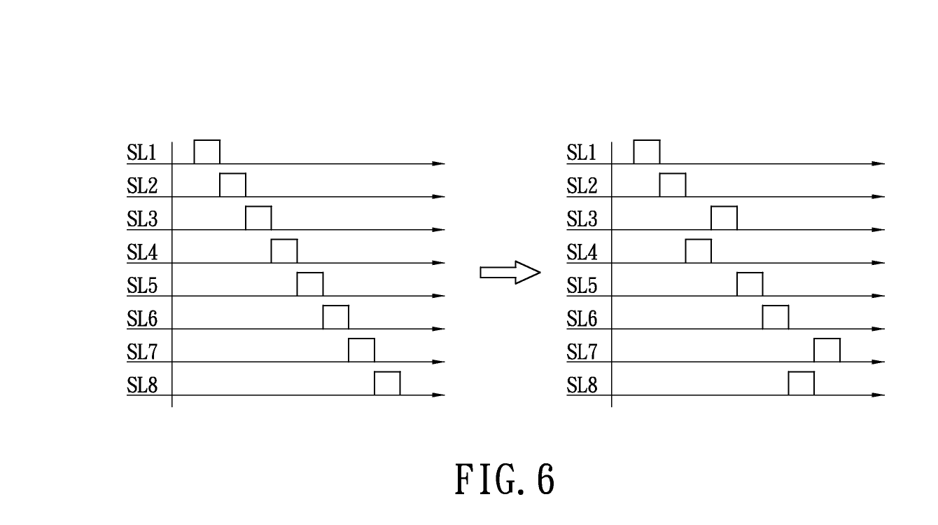

As following, there is an example describing when the scan sub-circuits 1311 and 1312 are adopted with the scan driving mode of the second kind, as shown in FIG. 4. When the timing controller 110 receives an original display data DATA, the timing controller 110 transmits a control signal CS1 and the original display data DATA to the data driver 120 and also transmits a control signal CS2 to the scan driver 130. The data driver 120 rearranges the original display data DATA received according to the scan driving mode (1-2-4-3) and through the line buffer 122. Referring to FIG. 5 as well, FIG. 5 shows a schematic diagram of a data driver rearranging the original display data DATA according to the embodiment of the instant disclosure. As shown in FIG. 5, according to the scan driving mode (1-2-4-3) and through the line buffer 122, the data driver 120 rearranges the original display data DATA by exchanging a third row with a fourth row, and exchanging a seventh row with the eighth row, and as a result, a new display data NDATA is generated and transmitted to the data driver 120 along with a control signal CS1. In the meantime, according to the scan driving mode (1-2-4-3), the data driver 120 transmits the order signal SES to the scan sub-circuits 1311-1312 of the scan driver 130 to adjust a sequence of scan driving of the scan driving signals of the scan sub-circuits. Referring to FIG. 6 as well, FIG. 6 shows a schematic diagram of the data driver adjusting a sequence of scan driving according to the embodiment of the instant disclosure. As shown in FIG. 6, the scan sub-circuits 1311-1312 adjust the sequence of scan driving so as to correspond to the scan driving mode (1-2-4-3) by exchanging scan line SL3 with scan line SL4 and exchanging scan line SL7 and scan line SL8. In other words, the sequence of scan driving of the scan sub-circuit 1311 is adjusted from the original “from the scan line SL1, to the scan line SL2, and to the scan line SL3, and then to the scan line SL4” into “from the scan line SL1, to the scan line SL2, and to the scan line SL4, and then to the scan line SL3.” On the other hand, the sequence of scan driving of the scan sub-circuit 1312 is adjusted from the original “from the scan line SL5, to the scan line SL6, and to the scan line SL7, and then to the scan line SL8” into “from the scan line SL5, to the scan line SL6, and to the scan line SL8, and then to the scan line SL7.”

Therefore, under the scan driving mode 1-2-4-3, when the scan sub-circuit 1311 transmits the scan driving signal to the first row of the display bock B1 through the scan line SL1, the data driver 120 transmits the first row of the new display data NDATA to the first row of the display block B1 of the display panel 140 through the data lines DL1-DL6. Then, when the scan sub-circuit 1311 transmits the scan driving signal to the second row of the display bock B1 of the display panel 140 through the scan line SL2, the data driver 120 transmits the second row of the new display data NDATA to the second row of the display block B1 through the data lines DL1-DL6. Afterwards, when the scan sub-circuit 1311 transmits the scan driving signal to the fourth row of the display bock B1 of the display panel 140 through the scan line SL4, the data driver 120 transmits the third row of the new display data NDATA to the fourth row of the display block B1 through the data lines DL1-DL6. Finally, when the scan sub-circuit 1311 transmits the scan driving signal to the third row of the display bock B1 of the display panel 140 through the scan line SL3, the data driver 120 transmits the fourth row of the new display data NDATA to the third row of the display block B1 through the data lines DL1-DL6.

When the scan sub-circuit 1312 transmits the scan driving signal to the first row of the display bock B1 through the scan line SL5, the data driver 120 transmits the first row of the new display data NDATA to the fifth row of the display block B1 of the display panel 140 through the data lines DL1-DL6. Then, when the scan sub-circuit 1311 transmits the scan driving signal to the second row of the display bock B1 of the display panel 140 through the scan line SL6, the data driver 120 transmits the sixth row of the new display data NDATA to the second row of the display block B1 through the data lines DL1-DL6. Afterwards, when the scan sub-circuit 1311 transmits the scan driving signal to the fourth row of the display bock B1 of the display panel 140 through the scan line SL8, the data driver 120 transmits the seventh row of the new display data NDATA to the fourth row of the display block B1 through the data lines DL1-DL6. Finally, when the scan sub-circuit 1311 transmits the scan driving signal to the third row of the display bock B1 of the display panel 140 through the scan line SL7, the data driver 120 transmits the eighth row of the new display data NDATA to the third row of the display block B1 through the data lines DL1-DL6.

It is worth mentioning that if the liquid crystal display apparatus 300 is under a scan driving mode whose alteration number is 1 (such as the third kind, 1-3-2-4, as shown in FIG. 4), then there is a better effect of power saving achieved, comparing to an effect of power saving achieved under the scan driving mode with an alteration number of 2; which means, the operating temperature of the data driver 120 is even reduced more. Moreover, in the present embodiment, the scan sub-circuits 1311 and 1312 are allowed to be under different kinds of scan driving mode; for example, the scan sub-circuit 1311 is under the scan driving mode of the sixth kind, 1-4-2-3, while the scan sub-circuit 1312 is under the scan driving mode of the seventeenth kind, 3-2-4-1, and it is not limited thereto. In addition, a work mechanism as mentioned above is not limited by a condition of dividing the display panel 140 into a plurality of display blocks, and the main idea of the instant disclosure is that after the data driver 120 rearranges the original display data DATA into the new display data NDATA, the scan driver 130 adjusts the sequence of scan driving of the scan driving signals according to the order signal SES received.

Accordingly, the instant closure is able to decrease a number between the high-low level voltage alteration of the data driver 120 to reduce a power consumption of the data driver 120 without an image changed during displaying, and further to reduce the operating temperature of the data driver 120 or the liquid crystal display apparatus 300.

[Embodiment of a Driving Mode]

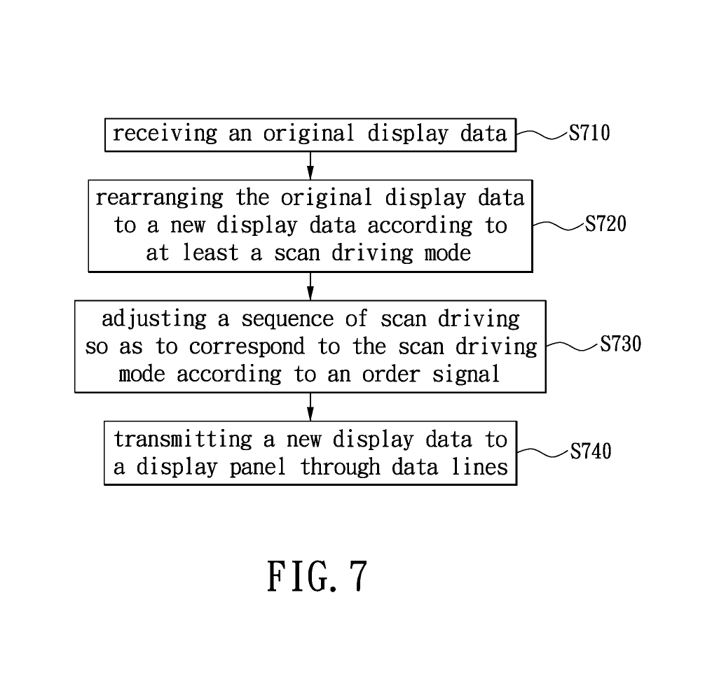

Referring to FIG. 7, FIG. 7 shows a flow chart of a driving mode according the embodiments of the instant disclosure. The driving mode of the embodiment is suitable for each of the liquid crystal display apparatus in the embodiments shown in FIGS. 1-3; therefore, please refer to FIGS. 1-3 for better understanding. In the present embodiment, steps of improving an operating temperature are described as follows: receiving an original display data (S710); rearranging the original display data to a new display data according to at least a scan driving mode (S720); adjusting a sequence of scan driving so as to correspond to the scan driving mode according to an order signal (S730); transmitting a new display data to a display panel through data lines (S740), wherein the sequence of the original display data corresponds to the sequence of scan driving before adjusting, and a sequence of the new display data corresponds to the sequence of scan driving after adjusting according to the scan driving mode.

As for related details in the steps of the driving method of the liquid crystal display apparatus, there are specific instructions of the embodiments in the FIGS. 1-6 as described above, and thus it is not repeated thereto. However, it is noticed that the steps of the present embodiment in FIG. 7 are set for a need to instruct easily, and thus the sequence of the steps is not used as a condition to limit the demonstration of the embodiments of the instant closure.

To sum up, the instant closure provides a liquid crystal display apparatus and the driving method thereof, which decreases a number of a high-low level voltage alteration without an image changed on the display panel, and economizes an overall power consumption of the data driver, and further reduces the operating temperature of the data driver.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A liquid crystal display apparatus, comprising:
a display panel;
a timing controller, receiving an original display data;
a data driver, coupled to the timing controller, and the data driver receiving the original display data and rearranging the original display data to be as a new display data according to at least a scan driving mode receiving the new display data and transmitting the new display data to a display panel through a data line; and
a scan driver, coupled to the timing controller, receiving an order signal transmitted by the timing controller and adjusting a sequence of scan driving so as to correspond to the scan driving mode according to the order signal;
wherein a sequence of the original display data corresponds to the sequence of scan driving before adjusting, and a sequence of the new display data corresponds to the sequence of scan driving after adjusting.

2. The liquid crystal display apparatus according to claim 1, wherein when the data driver rearranges the original display data according to the scan driving mode, the data driver transmits the order signal to the scan driver to adjust the sequence of scan driving according to the scan driving mode.

3. The liquid crystal display apparatus according to claim 1, wherein the scan driver includes M scan sub-circuits, and the display panel is divided into M display blocks; according to the order signal, each of the scan sub-circuits transmits N scan driving signals to the display block corresponded, wherein M and N are positive integers.

4. The liquid crystal display apparatus according to claim 3, wherein each of the scan sub-circuits adjusts the sequence of scan driving so as to correspond to the scan driving mode.

5. A driving method, the driving method comprising:
receiving an original display data;
rearranging the original display data to a new display data according to at least a scan driving mode;
adjusting a sequence of scan driving so as to correspond to the scan driving mode according to a control signal; and
transmitting a new display data to a display panel through a plurality of data lines;
wherein a sequence of the original display data corresponds to the sequence of scan driving before adjusting, and a sequence of the new display data corresponds to the sequence of scan driving after adjusting according to the scan driving mode,
wherein the driving method is applied into the liquid crystal display apparatus according to claim 1.

6. The driving mode according to claim 5, wherein when rearranging the original display data according to the scan driving mode, a timing controller transmits the order signal to a scan driver to adjust the sequence of scan driving according to the scan driving mode.

7. The driving mode according to claim 6, wherein the scan driver includes M scan sub-circuits, and the display panel is divided into M display blocks; according to the control signal, each of the scan sub-circuits transmits N scan driving signals to the display block corresponded, wherein M and N are positive integers.

8. The driving mode according to claim 7, wherein each of the scan sub-circuits adjusts the sequence of scan driving so as to correspond to the scan driving mode.
